(19) United States
(12) Patent Application Publication
(10) Pub. No.: US 2007/0160064 A1
(43) Pub. Date: Jul. 12, 2007

(54) Device supporting mobile internet protocol version 6 (Mobile IPv6)

(76) Inventors: Dae-Hyung Kwon, Seoul (KR); Kang-Young Moon, Yongin-si (KR); Hye-Sook Lim, Seoul (KR); Hye-Ran Kim, Seoul (KR); Sun-Gi Kim, Seoul (KR); Ju-Hyoung Mun, Seoul (KR); Won-Jung Kim, Seoul (KR); Suh-Young Jhee, Seoul (KR); Ha-Neul Chu, Seoul (KR)

Correspondence Address: Robert E. Bushnell, Suite 300, 1522 K Street, N.W., Washington, DC, 20005-1202, US

(21) Appl. No.: 11/645,636

(22) Filed: Dec. 27, 2006

(30) Foreign Application Priority Data
Jan. 9, 2006 (KR) 10-2006-0002349

(51) Int. Cl. H04L 12/28

(52) U.S. Cl. 370/395.52; 370/395.5

(57) ABSTRACT

A device supporting Mobile Internet Protocol version 6 (IPv6) includes: a mobile reception processor outputting home addresses of a mobile node and a correspondent node or mobility relevant header information according to whether a received packet is a Binding packet or a data packet; a binding cache storing Binding information that the mobile node has received; a binding update list storing Binding information that the mobile node has transmitted; a binding receiver receiving a Binding message that the correspondent node has created, receiving information on the home addresses of the mobile node and the correspondent node from the mobile reception processor, and providing information related to the Binding message to the binding cache and the binding update list; a binding transmitter receiving a request for creation of the Binding message, combining data using a calculated checksum, and creating and outputting a requested Binding message; and a mobile transmission processor determining a type of a header for Binding Update or Binding Acknowledgment through a Care-of Address (CoA) obtained by retrieving at least one of the binding cache and the binding update list, and creating and outputting a Mobile IPv6 header using the home addresses of the mobile node and the correspondent node received from the binding transmitter.

### CLAIM OF PRIORITY

This application makes reference to, incorporates the same herein, and claims all benefits accruing under 35 U.S.C. §119 from an application for APPARATUS FOR SUPPLYING MOBILE IPv6 earlier filed in the Korean Intellectual Property Office on the 9 Jan. 2006 and there duly assigned Serial No. 10-2006-0002349.

### BACKGROUND OF THE INVENTION

1. Field of the Invention

The present invention relates to a device supporting Mobile Internet Protocol version 6 (Mobile IPv6), and more particularly, to a device supporting Mobile IPv6 capable of realizing hardware-based Mobile IPv6 whereby all functions for providing mobility to a node are processed by hardware.

2. Description of the Related Art

Mobile Internet Protocol (IP) refers to a protocol for enabling communication to be continued without connections being dropped during handover using two IP addresses assigned to a mobile node, a permanent address and a new IP address after the mobile node moves to a new link. Mobile IP using existing Internet Protocol version 4 (IPv4) is restricted by limited address space due to the use of an IPv4 address space system, and has problems caused by triangular routing as well as the necessity of a foreign agent. Mobile Internet Protocol version 6 (Mobile IPv6) overcomes the drawbacks of the existing Mobile IPv4. Mobile IPv6 allows the mobile node to create a new address for itself on the new link, without the foreign agent, on the basis of IPv6. Accordingly, any node having mobility support can make use of Mobile IPv6 regardless of support for the link. Mobile IPv6 also supports route optimization to minimize delay caused by the route.

The following is a discussion of an operation flow of Mobile IP based on IPv6 when a node moves in a wireless network.

When a mobile node is located on a home link, a mobile node operates as an ordinary IPv6 node, and a packet is delivered through an ordinary IP routing method using a home address. A Mobile Node (MN) is a node that can move from one link to another and maintains connection with other nodes using its home address. A Correspondent Node (CN) is any node that communicates with the MN, and can be a mobile node or a stationary node. The Home Address (HoA) is a permanent address assigned to the MN on the home link. The CN can communicate with the MN using the home address. Furthermore, a Home Agent (HA) is a router that is located on the home link and registers a current location when the MN moves to a foreign link.

When the mobile node moves from the home link to another location, Mobile IPv6 is applied when the MN moves to a foreign link. The foreign link refers to any link on which the MN stays, excluding the home link. When moving to the foreign link, the MN is assigned a prefix from a foreign router, thereby obtaining a Care-of Address (CoA). In order to provide information on the CoA, the MN sends a “Binding Update” message to the HA. The term “binding” refers to the association of the home address with the CoA of the MN during a lifetime. The CN continues to maintain communication using the home address, along with information on the binding, even when the location of the MN is changed. If the MN intends to obtain a new CoA or maintain the binding information after the lifetime has lapsed, the MN must update the binding information.

The HA receiving the “Binding Update” message from the MN sends a “Binding Acknowledgment” message to the MN, indicating that binding has been established. When this binding has been established, the HA receives a packet which the CN sends to the home address of the MN on behalf of the MN, tunnels the received packet using the CoA of the MN, and sends the tunneled packet to a current location of the MN. Furthermore, when sending a packet to the CN, the MN attaches another IP header to the original packet, and tunnels the packet to the HA first. Then, the HA decapsulates the tunneled packet to detach the IP header from the original packet, and sends the decapsulated packet to the CN. The MN can thus continue communication with the CN. The HA tunnels and sends the packet, which is received from the MN, to a current location of the MN. When moving to the foreign link, the MN notifies the HA of the current location using the CoA, a temporary address, assigned at the moved location.

In a direct communication method to which route optimization is applied when the mobile node moves to another location, Mobile IPv6 enables direct communication with the CN by supporting route optimization, in addition to the communication method proposed above. This is nothing but a method of performing direct communication between the MN and the CN. When receiving a packet from the CN through tunneling, the MN sends a Binding Update message destined for the CN. The CN receiving the Binding Update message sends a Binding Acknowledgment message corresponding to the Binding Update message, indicating that binding has been established. In this manner, when the binding has been established between the MN and the CN, direct communication is possible between the two nodes without the HA.

As discussed above, Mobile IPv6 allows the MN to continue communication with the CN maintaining connection during handover. In other words, Mobile IP is characterized by rapidly detecting movement of the MN to a new link, establishing a new binding, and supporting a service in which a user is not aware of the movement. These functions of Mobile IPv6 are generally provided through software of the node.

However, when Mobile IP is implemented using software, it is natural for the node to be interfered or controlled by its Central Processing Unit (CPU) when packets have to be rapidly created, exchanged and processed in order to detect movement of the node and establish a new binding. For this reason, there is increasing need for Mobile IP capable of more rapidly coping with movement on a link and minimizing loss of packets in handover.

### SUMMARY OF THE INVENTION

It is an object of the present invention to provide a device supporting Mobile Internet Protocol version 6 (IPv6) and an IPv6 mobile node, the device enabling a Central Processing Unit (CPU) of the mobile node to be devoted to application programs, and mobility support functionality of Mobile IPv6 to be realized with separate hardware.

According to one aspect of the present invention, a Mobile Internet Protocol version 6 (IPv6) reception module of a device supporting Mobile IPv6 for a mobile node adapted to communicate with a correspondent node using IPv6 is provided, the Mobile IPv6 reception module including: a mobile reception processor adapted to output either home addresses of the mobile node and the correspondent node or mobility relevant header information according to whether a received packet is a Binding packet or a data packet; a binding cache adapted to store Binding information received by the mobile node; a binding update list adapted to store Binding information transmitted by the mobile node; and a binding receiver adapted to receive a Binding message created by the correspondent node, to receive information on the home addresses of the mobile node and the correspondent node from the mobile reception processor, and to provide information related to the Binding message to the binding cache and the binding update list.

The binding receiver is preferably adapted to transmit information on at least one of the home address of the mobile node, the home address of the correspondent node, a care-of address of the correspondent node, a sequence number, and a lifetime to the binding cache upon the Binding message being a Binding Update message; and to transmit information on at least one of the home address of the mobile node, a care-of address of the mobile node, the home address of the correspondent node, a sequence number, a lifetime, and status information to the binding update list upon the Binding message being a Binding Acknowledgment message.

The Mobile IPv6 reception module preferably further includes an IPv6 receiver adapted to effect IPv6 header processing.

The mobile reception processor is preferably adapted to transmit the home addresses of the mobile node and the correspondent node to the binding receiver upon the received packet being a Binding packet, and to transmit an IP header having a mobility relevant part thereof removed to the IPv6 receiver upon the received packet being a data packet.

The Mobile IPv6 reception module preferably further includes a checksum verifier adapted to verify whether or not a checksum of an externally input packet matches a calculated checksum.

The mobile reception processor is adapted to preferably create a pseudo header for calculating the checksum, and to provide the pseudo header to the checksum verifier.

The Mobile IPv6 reception module preferably further includes a node status detector adapted to detect a current status of the mobile node with respect to whether the mobile node is currently located on a home link or a foreign link. The Mobile IPv6 reception module preferably further includes a packet parser adapted to sort headers of packets received from external Media Access Control (MAC) by types, to transmit the sorted headers to either the mobile reception processor or the binding receiver, and to extract and output data except for the header. The Mobile IPv6 reception module preferably further includes a reception Random Access Memory (RAM) adapted to receive and store the data extracted and output from the packet parser. The Mobile IPv6 reception module preferably further includes: a User Datagram Protocol (UDP) receiver adapted to perform UDP header processing on the received packet; and a Transmission Control Protocol (TCP) receiver adapted to perform TCP header processing on the received packet.

The binding cache is preferably adapted to store a Care-of Address (CoA) of the correspondent node in a table.

According to another aspect of the present invention, a Mobile Internet Protocol version 6 (IPv6) transmission module of a device supporting Mobile IPv6 for a mobile node adapted to communicate with a correspondent node using IPv6 is provided, the Mobile IPv6 transmission module including: a binding transmitter adapted to receive a request for creation of a Binding message, to combine data using a calculated checksum, and to create and output a requested Binding message; a binding cache adapted to store Binding information received by the mobile node; a binding update list adapted to store Binding information transmitted by the mobile node; and a mobile transmission processor adapted to determine a type of a header for Binding Update or Binding Acknowledgment through a Care-of Address (CoA) obtained by retrieving at least one of the binding cache and the binding update list, and to create and output a Mobile IPv6 header using home addresses of the mobile node and the correspondent node received from the binding transmitter.

The mobile transmission processor is preferably adapted to retrieve only the binding cache upon the message to be created being a Binding Update message, and to retrieve only the binding update list upon the message to be created being a Binding Acknowledgment message.

The Mobile IPv6 transmission module preferably further includes an IPv6 transmitter adapted to perform IPv6 header processing, and to output the IPv6 header to the mobile transmission processor. The Mobile IPv6 transmission module preferably further includes a network interface adapted to combine the header and application program data to create a packet, and to transmit the created packet to a foreign network. The Mobile IPv6 transmission module preferably further includes: a User Datagram Protocol (UDP) receiver adapted to perform UDP header processing on the packet to be transmitted; and a Transmission Control Protocol (TCP) receiver adapted to perform TCP header processing on the packet to be transmitted.

According to still another aspect of the present invention, a device supporting Mobile Internet Protocol version 6 (IPv6) for a mobile node adapted to communicate with a correspondent node using IPv6 is provided, the device including: a mobile reception processor adapted to output either home addresses of the mobile node and the correspondent node or mobility relevant header information according to whether a received packet is a Binding packet or a data packet; a binding cache adapted to store Binding information received by the mobile node; a binding update list adapted to store Binding information transmitted by the mobile node; a binding receiver adapted to receive a Binding message created by the correspondent node, to receive information on the home addresses of the mobile node and the correspondent node from the mobile reception processor, and to provide information related to the Binding message to the binding cache and the binding update list; a binding transmitter adapted to receive a request for creation of the Binding message, to combine data using a calculated checksum, and to create and output a requested Binding message; and a mobile transmission processor adapted to determine a type of a header for Binding Update or Binding Acknowledgment through a Care-of Address (CoA) obtained by retrieving at least one of the binding cache and the binding update list, and to create and output a Mobile IPv6 header using the home addresses of the mobile node and the correspondent node received from the binding transmitter.

The device preferably further includes: a packet parser adapted to sort headers of the packets received from external Media Access Control (MAC) by types, to transmit the sorted headers to either the mobile reception processor or the binding receiver, and to extract and output data except for the header; and a network interface adapted to combine the header and application program data to create a packet, and to transmit the created packet to a foreign network. The device preferably further includes a neighbor searcher adapted to perform MAC address retrieval from an IP address, default router selection, neighbor unreachability detection, and movement detection.

The neighbor searcher is preferably adapted to receive an Internet Control Message Protocol (ICMP) relevant message from the packet parser, to transmit necessary information to a Central Processing Unit (CPU) of the mobile node, to create an ICMP packet upon neighbor searching or the received packet giving rise to trouble, and to transmit the created ICMP packet to the network interface.

The device preferably further includes a host interface adapted to relay a control or data flow exchanged with a Central Processing Unit (CPU) of the mobile node.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A, 1B, and 1C are views of an operation flow of Mobile Internet Protocol (IP) based on Internet Protocol version 6 (IPv6) when a node moves in a wireless network;

FIG. 2 is a block configuration of a device supporting Mobile IPv6 according to an exemplary embodiment of the present invention;

FIG. 3 is a view of data packet reception flow in a Mobile IPv6 support device according to an exemplary embodiment of the present invention;

FIG. 4 is a view of data packet transmission flow in a Mobile IPv6 support device according to an exemplary embodiment of the present invention;

FIG. 5 is a view of Binding packet transmission flow in a Mobile IPv6 support device according to an exemplary embodiment of the present invention; and

FIG. 6 is a view of Internet Control Message Protocol (ICMP) packet transmission flow in a Mobile IPv6 support device according to an exemplary embodiment of the present invention.

### DETAILED DESCRIPTION OF THE INVENTION

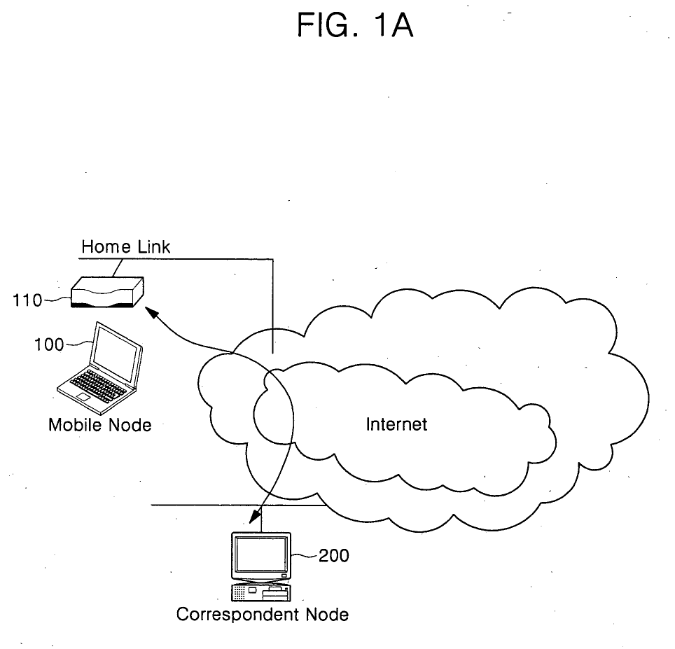

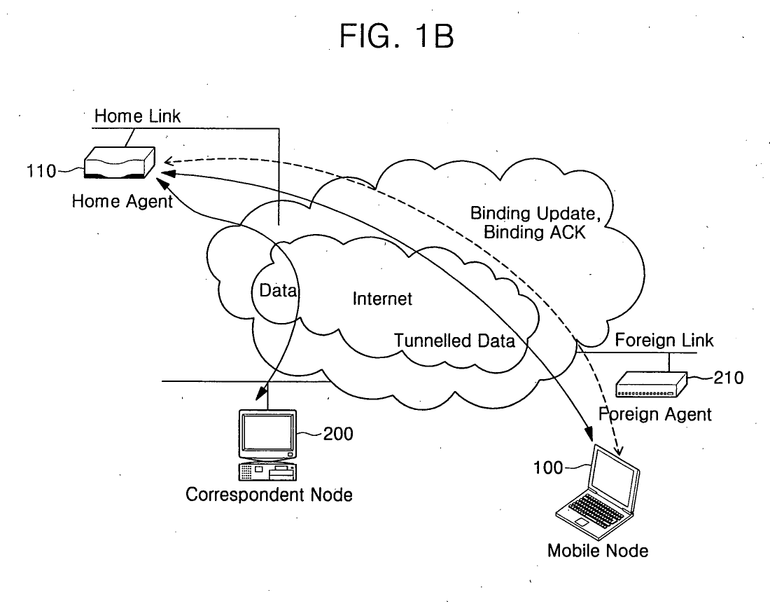

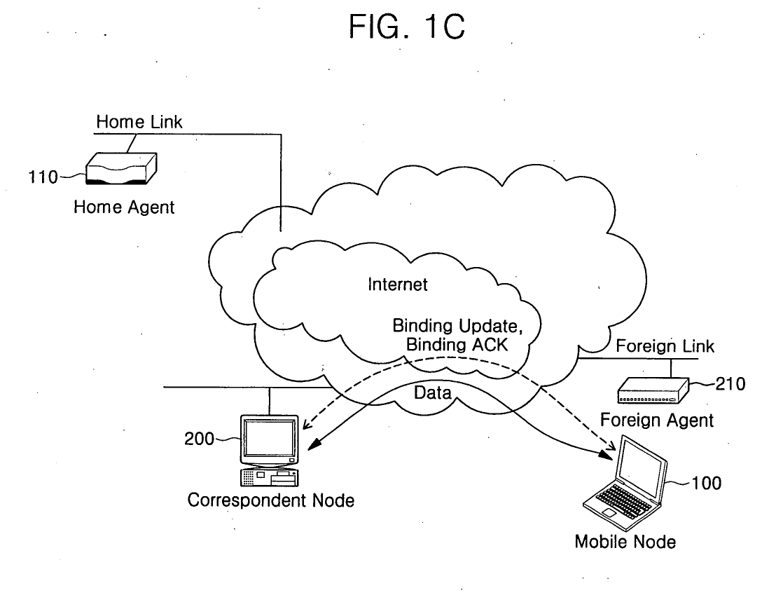

FIGS. 1A, 1B, and 1C are views of an operation flow of Mobile Internet Protocol (IP) based on Internet Protocol version 6 (IPv6) when a node moves in a wireless network.

FIG. 1A is a view of an example in which a mobile node is located on a home link.

When located on a home link as in FIG. 1A, a mobile node operates as an ordinary IPv6 node, and a packet is delivered through an ordinary IP routing method using a home address. The Mobile Node (MN) 100 refers to a node that can move from one link to another and maintains connection with other nodes using its home address. A Correspondent Node (CN) 200 refers to any node that communicates with the MN, and can be a mobile node or a stationary node. The Home Address (HoA) is a permanent address assigned to the MN 100 on the home link. The CN 200 can communicate with the MN using the home address. Furthermore, a Home Agent (HA) 10 is a router that is located on the home link and registers a current location when the MN 100 moves to a foreign link.

FIG. 1B is a view of a flow of packets when the mobile node moves from the home link to another location.

Mobile IPv6 is applied when the MN 100 moves to a foreign link as in FIG. 1B. The foreign link refers to any link on which the MN 100 stays, excluding the home link. When moving to the foreign link 100 as in FIG. 1B, the MN 100 is assigned a prefix from a foreign router, thereby obtaining a Care-of Address (CoA). In order to provide information on the CoA, the MN 100 sends a “Binding Update” message to the HA 110. The term “binding” refers to the association of the home address with the CoA of the MN during a lifetime. The CN 200 continues to maintain communication using the home address, along with information on the binding, even when the location of the MN 100 is changed. If the MN 100 intends to obtain a new CoA or maintain the binding information after the lifetime has lapsed, the MN 100 must update the binding information.

The HA 110 receiving the “Binding Update” message from the MN 100 sends a “Binding Acknowledgment” message to the MN 100, indicating that binding has been established. When this binding has been established, the HA 110 receives a packet which the CN 200 sends to the home address of the MN 100 on behalf of the MN, tunnels the received packet using the CoA of the MN 100, and sends the tunneled packet to a current location of the MN. Furthermore, when sending a packet to the CN 200, the MN 100 attaches another IP header to the original packet, and tunnels the packet to the HA 110 first. Then, the HA 110 decapsulates the tunneled packet to detach the IP header from the original packet, and sends the decapsulated packet to the CN 200. The MN 100 can thus continue communication with the CN 200. The HA 110 tunnels and sends the packet, which is received from the MN 100, to a current location of the MN. When moving to the foreign link, the MN 100 notifies the HA 110 of the current location using the CoA, a temporary address, assigned at the moved location.

FIG. 1C is a view of a direct communication method to which route optimization is applied when the mobile node moves to another location.

Mobile IPv6 enables direct communication with the CN by supporting route optimization, in addition to the communication method proposed in FIG. 1B. This is nothing but a method of performing direct communication between the MN and the CN, as illustrated in FIG. 1C. In FIG. 1C, when receiving a packet from the CN 200 through tunneling, the MN 100 sends a Binding Update message destined for the CN 200. The CN 200 receiving the Binding Update message sends a Binding Acknowledgment message corresponding to the Binding Update message, indicating that binding has been established. In this manner, when the binding has been established between the MN 100 and the CN 200, direct communication is possible between the two nodes without the HA.

Hereinafter, exemplary embodiments of the present invention are described in detail with reference to the accompanying drawings.

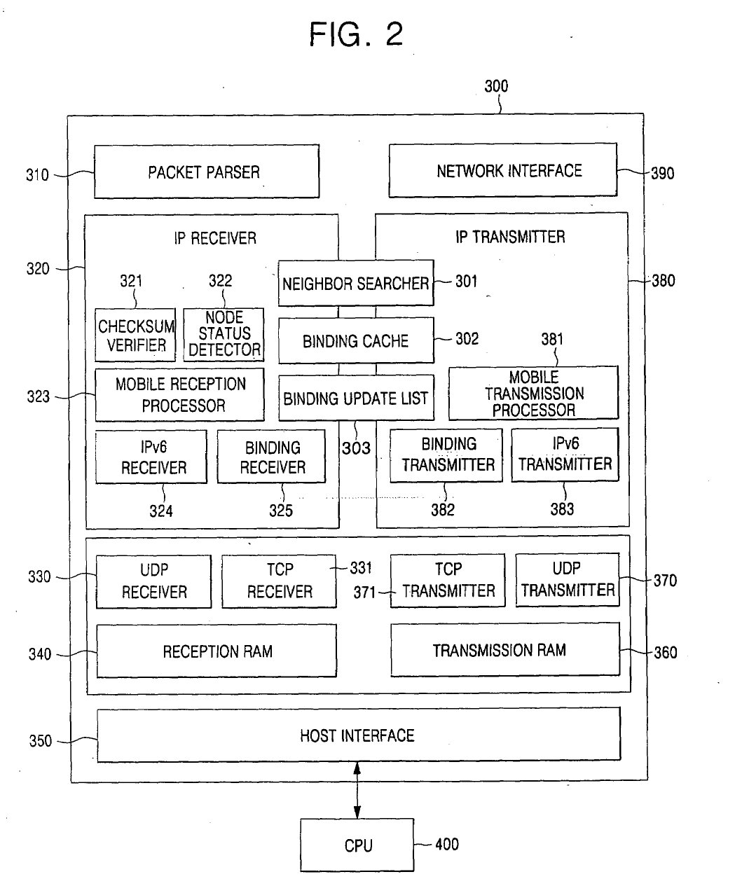

FIG. 2 is a block configuration of a device supporting Mobile IPv6 according to an exemplary embodiment of the present invention.

The device 300 supporting Mobile IPv6 includes a packet parser 310, an Internet Protocol (IP) receiver 320, a User Datagram Protocol (UDP) receiver 330, a Transmission Control Protocol (TCP) receiver 331, a reception Random Access Memory (RAM) 340, a host interface 350, a transmission RAM 360, an UDP transmitter 370, a TCP transmitter 371, an IP transmitter 380, and a network interface 390.

The packet parser 310 extracts a header from a packet received through external Media Access Control (MAC), provides the header to other blocks within the Mobile IPv6 support device 300, and stores data of the packet in the reception RAM 340. The network interface 390 combines a header created by the transmission blocks and application program data output by a Central Processing Unit (CPU) 400, thereby creating a packet and then transmitting the created packet to the outside. The host interface 350 is a block taking charge of communication between the CPU 400 and the Mobile IPv6 support device 300.

The IP receiver 320 receives and processes a packet from the outside, i.e. a wireless environment, and more particularly, receives the packet from the packet parser 310, and performs Mobile IPv6 processing on the received packet. The IP transmitter 380 performs Mobile IPv6 processing on the application program data received from the CPU 400, thereby re-combining and creating the packet, and transmitting the created packet to the outside.

Meanwhile, the UDP receiver 330, TCP receiver 331, UDP transmitter 370, and TCP transmitter 371 blocks take charge of header processing corresponding to each protocol. The reception RAM 340 stores the application program data of the received packet, and the transmission RAM 360 stores the application program data transmitted from the CPU 400 to the outside. The data stored in the reception RAM 340 is transmitted to the CPU 400 through the host interface 350, and the data stored in the transmission RAM 360 is combined with the header created by the IP transmitter 380, TCP transmitter 371 or UDP transmitter 370, and then transmitted to the outside through the network interface 390.

Structures of the IP receiver 320 and the IP transmitter 380 which are characteristic of the present invention are described in greater detail as follows.

The IP receiver 320 includes a checksum verifier 321, a node status detector 322, a mobile reception processor 323, and a binding receiver 325. The IP transmitter 380 includes a mobile transmission processor 381, a binding transmitter 382, and an IPv6 transmitter 383. Blocks that are common to the IP receiver 320 and the IP transmitter 380 include a neighbor searcher 301, a binding cache 302, and a binding update list 303.

The IP receiver 320 is described as follows.

The checksum verifier 321 verifies whether or not a packet has an error using a checksum of the received packet. The checksum verifier 321 receives a checksum of the packet data from the packet parser 310, and a pseudo header from the mobile reception processor 323, and then verifies whether or not the checksum of the packet received from the outside is matched with a calculated checksum.

The node status detector 322 serves to detect a current status of a Mobile Node (MN), and detects whether the MN is located on a home link or a foreign link. To this end, the node status detector 322 receives information on whether the MN has moved to the foreign link or is located on the home link from the neighbor searcher 301, maintains the status of the MN, and delivers that status to another mobile relevant block. For example, when receiving a Care-of Address (CoA) of the MN from the neighbor searcher 301 together with a signal that the MN has moved from the home link to the foreign link, the node status detector 322 requests a Home Agent (HA) to transmit a Binding to the binding transmitter 382. Furthermore, when the MN moves to a new link again, the node status detector 322 transmits a command signal, which instructs the binding update list 303 to update a Binding Update list, to the binding update list 303. When the MN returns to the home link again, the node status detector 322 transmits a signal, which instructs the binding update list 303 to delete all Bindings, to the binding update list 303.

The mobile reception processor 323, that is the block performing the functionality of Mobile IPv6, receives the IP headers other than a Mobility Header from the packet parser 310, processes data of the packet, and delivers the processed data to another block. When receiving the data from the packet parser 310, the mobile reception processor 323 detects the length of header and a Next Header field to determine the type of header. When the last field, the Next Header field, of the received packet is determined to be the Mobility Header, i.e. has a value of 135, the received packet is a binding packet. If not, the received packet is a data packet. When the received packet is a binding packet, the mobile reception processor 323 sends information on a home address of the MN and a home address of a Correspondent Node (CN) to the binding receiver 325. A binding message received into the binding receiver 325 contains no home address. Hence, the mobile reception processor 323 must provide the information of the home address. When the received packet is a data packet, the mobile reception processor 323 creates a 40-byte IP header using a home address, and transmits the created IP header to an IPv6 receiver 324. Because the upper layers are not aware of the binding or CoA in principle, the mobility relevant headers are not transmitted to the IPv6 receiver 324.

The mobile reception processor 323, also creates a pseudo header in order to calculate a checksum of all of the received packets, and transmits the created pseudo header to the checksum verifier 321.

In addition, when receiving a tunneled packet, the mobile reception processor 323 requests the binding transmitter 382 to transmit a Binding Update message for the purpose of route optimization. When the CN does not know the CoA of the MN, a packet transmitted by the CN is tunneled through the HA, and then transmitted to the MN. Thus, when the tunneled packet has been received, the mobile reception processor 323 sends the Binding Update message to the CN, which transmits the packet for the route optimization, in order to notify the CoA to the CN.

The binding receiver 325 receives and processes a Binding message. The Binding message is divided into two types: Binding Update and Binding Acknowledgment. The binding receiver 325 receives a Mobility Header and a Binding message from the packet parser 310. The binding receiver 325 receives home addresses of the MN and CN from the mobile reception processor 323 because the Mobility Header and the Binding message do not contain information on a home address. The Mobility Header is defined in Mobile IPv6, and is an extension header used by MNs, CNs, and HAs in all messaging related to the creation and management of bindings. The Mobility Header has various fields: a 8-bit Payload Proto field that identifies the type of header immediately following the Mobility Header, a Header Len field, an MH Type field, a Message Data field, and so on. The Message Data field is a variable length field, and contains data specific to the indicated Mobility Header type.

The binding receiver 325 parses the MH Type field of the Mobility Header. As a result, in the case of a Binding Update packet, the binding receiver 325 transmits information on a home address of the MN, a home address of the CN, a CoA of the CN, a sequence number, a lifetime, and a node status to the binding cache 302. However, in the case of a Binding Acknowledgment packet, the binding receiver 325 transmits information on a home address of the MN, a CoA of the MN, a home address of the CN, a sequence number, a lifetime, and a node status to the binding update list 303.

Meanwhile, the IPv6 receiver 324 takes charge of the processing of an IPv6 header.

The IP transmitter 380 is described below as follows.

The binding transmitter 382 is a block creating a Binding message. A request to create the Binding message can be received from four peripheral blocks, and includes a request from the node status detector 322 to create the Binding Update message when moving a link, a request from the mobile reception processor 323 to create the Binding Update message for route optimization when receiving a tunneled packet, a request of the Binding Update message from the binding update list 303 when a lifetime of an arbitrary entry of the binding update list 303 reaches a threshold value, and a request of a Binding Update from the binding cache 302 when receiving the Binding Update message.

These binding requests received from the respective blocks are sequentially processed. The binding transmitter 382 receiving the request to create the Binding message stores a corresponding message in each header field, and calculates a checksum. Furthermore, in order to make an IP header of the message, the binding transmitter 382 requests the mobile transmission processor 381 to make the IP header. When the calculation of the checksum has been completed, the binding transmitter 382 combines data, and transmits the combined data to the network interface 390. In this case, when notifying the network interface 390 that the data will be transmitted, and then receiving its response from the network interface 390, the binding transmitter 382 transmits the data by two bytes per clock, and indicates the end of the data by transmitting an End signal along with the last two bytes.

The mobile transmission processor 381 is a block creating a Mobile IP header. The mobile transmission processor 381 creates a Mobile IPv6 header by receiving the IPv6 header from the IPv6 transmitter 383 or receiving the home address of the MN, the home address of the CN, the length information, etc. from the binding transmitter 382. Because source and destination addresses of the data received from each block are home addresses, the mobile transmission processor 381 must obtain a CoA through retrieval of the binding cache 302 and binding update list 303 and determine the type of header. In the case of the data received from the IP block, the mobile transmission processor 381 retrieves both of the binding cache 302 and the binding update list 303, thereby obtaining information on the CoA. When the received message is a Binding Update message of Binding messages, the CoA of the MN has been already determined, and thus the mobile transmission processor 381 retrieves only the binding cache 302. When the received message is a Binding Acknowledgment message of Binding messages, a packet is a Binding Acknowledgment packet of the CoA of the CN, and thus the mobile transmission processor 381 retrieves only the binding update list 303 and determines whether or not to use the CoA of the MN. When a current MN is located on a home link, the mobile transmission processor 381 retrieves only the binding cache 302, but not the binding update list 303.

As described above, the mobile transmission processor 381 determines the type of header based on input data and retrieved results, creates the mobile header, and transmits the created mobile header to the network interface 390. Furthermore, the mobile transmission processor 381 transmits the outermost destination address to the neighbor searcher 301 in order to make a MAC header.

Meanwhile, the IPv6 transmitter 383 takes charge of the processing of an IPv6 header.

Next, the blocks that are commonly applied to the IP receiver 320 and the IP transmitter 380 are described as follows.

The binding cache 302 is a place for storing the received Binding Update, and maintains information on the CoA of the CN in the type of table. Each entry of the binding cache 302 includes a home address of the MN, a home address of the CN, a CoA of the CN, a sequence number, a lifetime, and so on. In order to maintain each entry, the binding cache 302 has an entry identified by a Valid Bit, a Lifetime Counter, a Hit Bit, and so on.

When receiving the Binding data from the binding receiver 325, the binding cache 302 sequentially retrieves its entries whether or not a matched entry exists using the home addresses of the MN and CN. If the matched entry exists, the binding cache 302 compares sequence 8 numbers, and checks whether or not an input sequence number is greater than a stored sequence number. If the input sequence number is greater than the stored sequence number, the binding cache 302 updates information of a corresponding entry. If the input sequence number is less than or equal to that stored in the entry, this is considered to be an error. The binding cache 302 records a “sequence number error” in the Status field of the Binding Acknowledgment packet, and transmits the packet. If the matched entry does not exist, the binding cache 302 stores the input sequence number in a new entry.

The binding cache 302 requests the binding transmitter 382 to create and transmit a Binding Acknowledgment packet in order to send a Binding Acknowledgment to a subsequently received Binding Update message. The binding transmitter 382 makes a request for entry retrieval to the binding cache 302 in order to check whether or not the binding cache 302 knows the CoA of a destination node when transmitting the packet. If a matched entry exists through the retrieval, the binding cache 302 transmits a CoA of the CN to the binding transmitter 382 along with ACK and Match signals. However, ifno matched entry exists, the binding cache 302 transmits only the ACK signal.

The binding cache 302 performs the following process by means of background processing in order to properly maintain the number of entries on its table and delete any unused entry from the table. Once data is stored in the table, the binding cache 302 sets a Valid Bit and a Hit Bit to 1, and stores an input lifetime in a Lifetime Counter. Then, the binding cache 302 reduces the Lifetime Counter with respect to a valid entry one by one, and sets the Hit Bit to 0 at every constant time. When the Lifetime Counter is less than a threshold value, and the Hit Bit is set to 1, the binding cache 302 considers a corresponding entry to be continuously used, and thus requests a Binding Request from the binding transmitter 382. The binding cache 302 can thus maintain the Binding. Furthermore, when the Lifetime Counter is less than a threshold value, and the Hit Bit is set to 0, the binding cache 302 considers a corresponding entry to be unused, and thus deletes the entry when the Valid Counter becomes 0.

The binding update list 303 is a place where information about transmitted Binding is stored, and is managed by the MN. The binding update list 303 can store an address of a node transmitting the Binding, a CoA of the MN, a lifetime, and so on, and can re-transmit a Binding Update message about the time when the lifetime is expired. The MN can transmit a packet to the CN directly without the HA using its CoA when an address of the CN exists in its list. The binding update list 303 has each table entry in which a home address of the CN, a CoA of the MN, a home address of the MN, a sequence number, a lifetime, an H bit, and so on are stored. In order to maintain each entry, the binding update list 303 has a Valid Bit, a Lifetime Counter, and a Hit Bit. For the process of waiting for an Acknowledgment packet, each entry of the binding update list 303 stores Retrans_times, Wait_Ack_Counter, and State.

The binding transmitter 382 transmits a Binding Update, and then transmits that information to the binding update list 303. The binding update list 303 updates a corresponding entry when the received information is requested by the binding transmitter 382, and stores a Binding requested by another block in a new entry. Furthermore, the binding update list 303 waits for a Binding Acknowledgment packet to a transmitted Binding Update message. The binding update list 303 sets a State in the state of Wait_ACK, and increases the Wait_Ack_Counter one by one. When the Wait_Ack_Counter exceeds a preset time, the binding update list 303 requests the binding transmitter 382 to re-transmit the Binding Update message. This re-transmission is repeated up to the preset number of times. If the Binding Acknowledgment packet is not received up to that time, the entry is considered to be invalid. When receiving the Binding Acknowledgment packet from the binding receiver 325, the binding update list 303 sequentially retrieves its entries whether or not a matched entry exists by use of the home addresses of the MN and CN in order to find an entry corresponding to the Binding Acknowledgment packet. If the matched entry exists, the binding update list 303 compares sequence numbers, and checks whether or not an input sequence number is matched with a stored sequence number. If the input sequence number is matched with the stored sequence number, the binding update list 303 updates information of the corresponding entry.

The binding transmitter 382 makes a request for entry retrieval to the binding update list 303 in order to check whether or not the CN knows the CoA of the MN when transmitting the packet. If a matched entry exists through the retrieval, the binding update list 303 transmits the CoA of the MN to the binding transmitter 382 along with ACK and Match signals. However, if no matched entry exists, the binding update list 303 transmits only the ACK signal.

In order to maintain its table, the binding update list 303 decreases the Lifetime Counter with respect to a valid entry one by one, and sets the Hit Bit to 0 at every constant time. When the Lifetime Counter is less than a threshold value, and the Hit Bit is set to 1, the binding update list 303 considers the corresponding entry to be continuously used, and thus requests a Binding Update message from the binding transmitter 382. The binding update list 303 can thus maintain the Binding. Furthermore, when the Lifetime Counter is less than a threshold value, and the Hit Bit is set to 0, the binding update list 303 considers a corresponding entry to be unused, and thus deletes the entry when the Valid Counter becomes 0. Furthermore, when receiving a signal indicating movement to another link from the neighbor searcher 301, the binding update list 303 sequentially sends Binding Updates setting a State of the valid entry in the state of Move, and updates a list. When receiving a signal indicating return to a home link, the binding update list 303 sets the State in the state of Move, sets the lifetime of a transmitted Binding Update to 0, and matches the CoA of the MN with the home address of the MN, thereby canceling the Binding.

The neighbor searcher 301 serves to find out a MAC address of a first hop through which a pack passes when the packet is transmitted to a destination IP address. Furthermore, the neighbor searcher 301 performs selection of a default router, Neighbor Unreachability Detection (NUD), and movement detection. The neighbor searcher 301 comprises sub-blocks such as RxND, NDP, TxND, and so on. The RxND receives Router Advertisement (RA), Neighbor Solicitation (NS), and Neighbor Advertisement (NA) packets from the packet parser 310, and checks whether or not each packet has an error. Then, the RxND transmits that information to the NDP only when no error exists in the received message. The TxND creates an ND message according to a command of the NDP, stores the packet until the network interface 390 is prepared, and transmits the packet to the network interface 390. The NDP manages a neighbor cache required for address translation, a default router list, a prefix list. When transmitting the ND message, the NDIP transmits a signal instructing the TxND to create the ND message to the TxND.

The neighbor searcher 301 manages information of the neighbor cache, and performs translation of IP addresses. The network interface 390 compares prefixes of the prefix list and destination addresses, and transmits a solicitation signal to the NDP together with the IP address of which it intends to be aware when the destination addresses are located on the same link (i.e. on-link). The neighbor searcher 301 receiving this solicitation retrieves matched information in the neighbor cache. When corresponding information exists in the neighbor cache, the neighbor searcher 301 transmits information on the MAC address to the network interface 390. However, when desired information does not exist in the neighbor cache, the neighbor searcher 301 creates the NS packet, and multicasts the created NS packet to all the other hosts on the same link. When a solicited NA is received in response to the NS, the neighbor searcher 301 obtains information on a desired address from the packet. At this time, a corresponding entry of the neighbor cache becomes a REACHABLE state. If an unsolicited NA or RA is received, the corresponding entry of the neighbor cache becomes a STALE state. Furthermore, the neighbor cache entry that receives no solicitation during a reachable time is converted from the REACHABLE state into the STALE state when the reachable time has lapsed. When receiving the solicitation in the STALE state, the STALE state is converted into a DELAY state, and a timer is adjusted to DELAY FIRST PROBE TIME (5 sec). If no packet is received from a corresponding Neighbor until the DELAY FIRST PROBE TIME has lapsed, the DELAY state is changed into a PROBE state. In the PROBE state, the NS packet is transmitted at every Retrans Time. When the packet is not received from the corresponding node until the reachable 8 time has lapsed after MAX_UNICAST_SOLICIT is transmitted, the Neighbor is considered to be unreachable. When the packet is received from the corresponding node in the DELAY or PROBE state, the DELAY or PROBE state is changed into the REACHABLE state. An entry is deleted when unused. More specifically, when unused for 10 seconds in the STALE state, the entry is considered not to communicate with the Neighbor, thereby being deleted.

The neighbor cache has 20 entries, and contains IsRouter and State indicating whether the entry is a router or a host, and an IP address and a MAC address. The default router list is updated whenever the RA is received. A default router transmitting the packet when the MN moves to another link than a home link makes use of a router acting as the HA. The selection of the default router is performed when the communication supported by the default router ends in failure. The default router has five entries, each of which contains a HA, a lifetime, and a router IP address. The prefix list is updated through options of the RA, i.e. prefix options. The prefix list has five entries, each of which contains a prefix, and a length of the prefix.

Meanwhile, the host interface 350 is a block taking charge of the communication between the CPU 400 and the Mobile IPv6 hardware, and operates in a slave mode of the CUP 400. The host interface 350 can be described making a distinction between a control flow and a data flow. The control flow contains information on the width of a bus and Wait relevant information which are received from the CPU 400, information about headers for commands given to hardware blocks and packets sent to the hardware blocks, Status information transmitted from the hardware blocks to the CPU 400, and control information required to exchange the packets including header information of a received packet. The communication is carried out through Command/Status Register (CSR) inside the host interface 350. The data flow serves to deliver data between the CPU 400 and the Mobile IPv6 support device 300, and is divided into a receiving flow for receiving data, and a transmitting flow for processing data into a packet and transmitting the packet. In the case of the receiving flow, the stored data is read into the reception RAM 340, and the CPU 400 is adapted to read out the data through an internal RxFIFO. In the case of the transmitting flow, the data to be transmitted is read out of the CPU 400, and stored in the transmission RAM 360 through an internal TxFIFO, and the network interface 390 is adapted to read out the data, and create and transmit a packet.

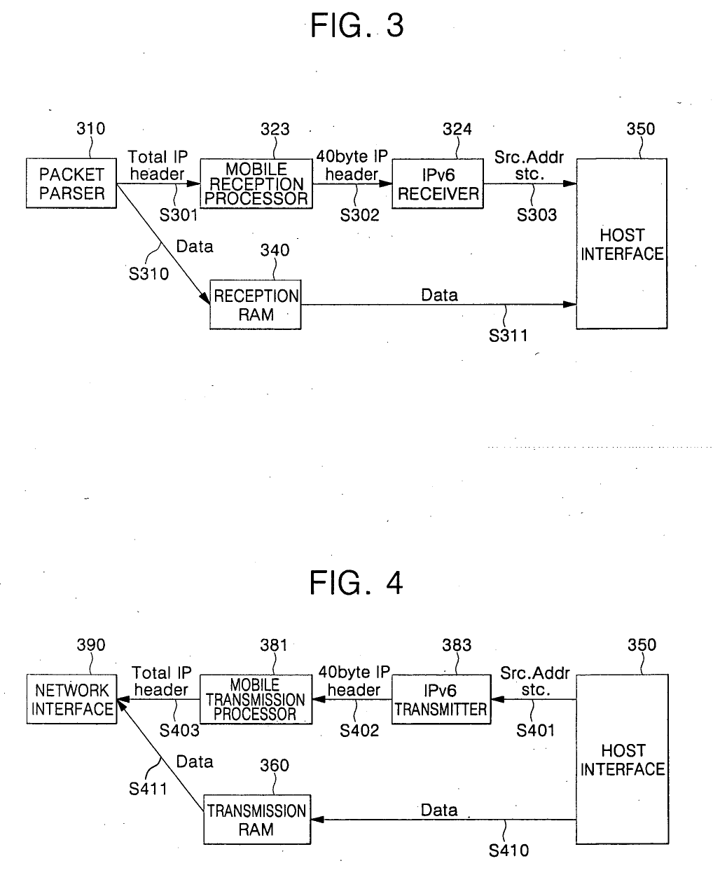

FIG. 3 is a view of data packet reception flow in a Mobile IPv6 support device according to an embodiment of the present invention.

In FIG. 3, the receiving flow of the data packet such as a TCP packet, a UDP packet or the like is illustrated. The packet parser 310 receiving the data packet provides an IP header to the mobile reception processor 323 (S301). The mobile reception processor 323 transmits the IP header of 40 bytes which removes mobility relevant functionality to the IPv6 receiver 324 (S302). The IPv6 receiver 324 receiving the 40-byte IP header performs IP header processing, and provides the result to the CPU 400 (S303).

The packet parser 310 directly stores TCP or UDP data of the packet in the reception RAM 340 (S310), and causes the CPU 400 to read out the TCP or UDP data through the host interface 350 (S311).

FIG. 4 is a view of data packet transmission flow in a Mobile IPv6 support device according to an embodiment of the present invention.

In FIG. 4, the transmitting flow of the data packet such as a TCP packet, a UDP packet or the like is illustrated. When an MN has a packet to be transmitted, the IPv6 transmitter 383 creates an IP header according to a command of the CPU which is input through the host interface 350 (S401). The IPv6 transmitter 383 transmits the created IP header to the mobile transmission processor 381 (S402). The mobile transmission processor 381 creates a header related to mobility functionality, and transmits the created header to the network interface 390 (S403).

Application program data to be transmitted is recorded on the transmission RAM 360 through the host interface 350 (S410). The network interface 390 reads the data out of the transmission RAM 360, combines the read-out data and the header in sequence, and transmits the combined result (S411).

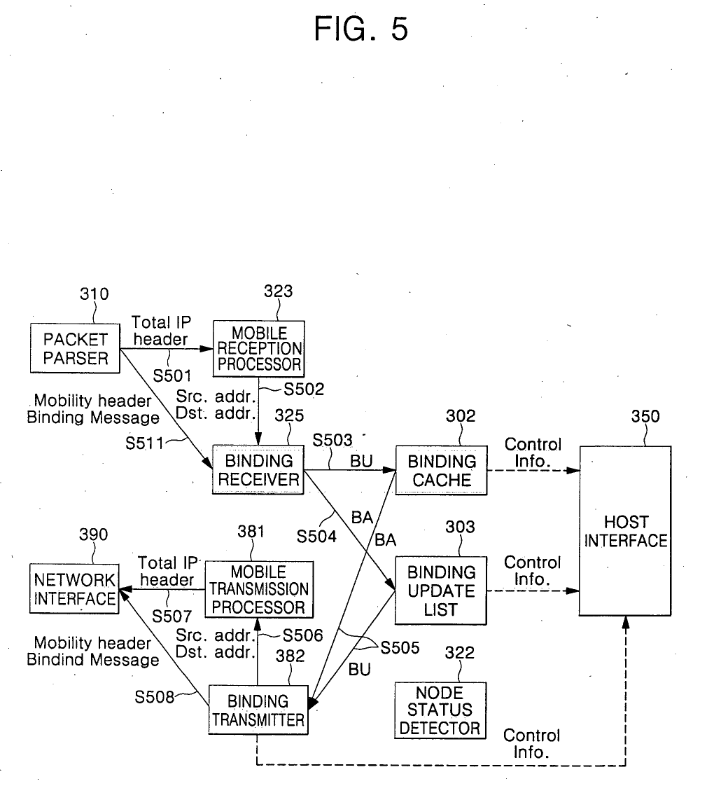

FIG. 5 is a view of Binding packet transmission flow in a Mobile IPv6 support device according to an embodiment of the present invention.

The Binding packet is processed, created, and transmitted by mobility relevant blocks without interference of the CPU 400.

The Binding packet includes a Binding Update (BU) packet, a Binding Acknowledgment (BA) packet, and so on. This packet is contained and transmitted in a Mobility Header of IPv6. When receiving the Binding packet, the packet parser 310 provides other IP headers than the Mobility Header to the mobile reception processor 323 (S501). The Mobility Header and Binding relevant information are transmitted to the binding receiver 325. The mobile reception processor 323 receiving the IP headers transmits the Binding relevant information extracted from each of the IP headers to the binding receiver 325 (S502). When the received Binding packet is a BU packet, the binding receiver 325 transmits a corresponding packet to the binding cache 302 (S503). However, when the received Binding packet is a BA packet, the binding receiver 325 transmits a corresponding packet to the binding update list 303 (S504).

When receiving a BU, and intending to transmit a BA or BU in response to the reception, the binding cache 302 or the binding update list 303 requests the binding transmitter 382 to create and transmit a Binding packet (S505). The binding transmitter 382 creates the Mobility Header and Binding information, and then requests the mobile transmission processor 381 to create an IP header (S506). The header and Binding information created by the binding transmitter 382 and mobile transmission processor 381 are transmitted to the network interface 390, and the network interface 390 combines and transmits packets.

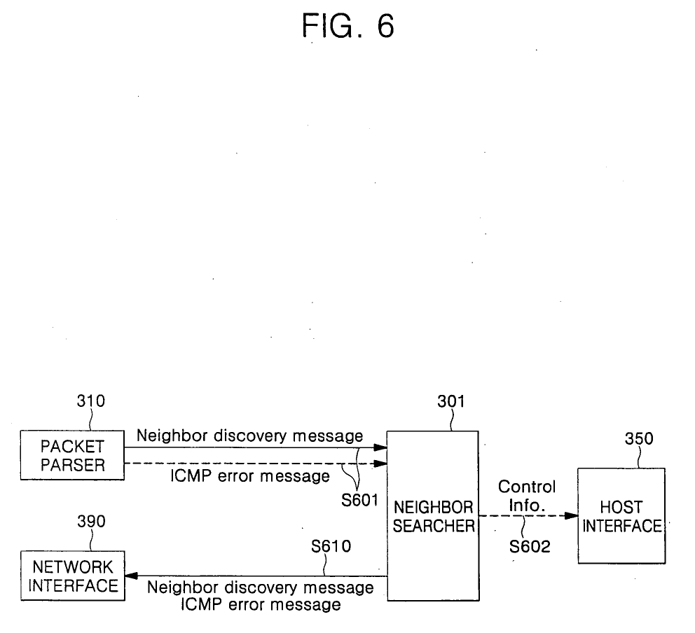

FIG. 6 is a view of Internet Control Message Protocol (ICMP) packet transmission flow in a Mobile IPv6 support device according to an embodiment of the present invention.

An ICMP relevant packet is also processed, created, and transmitted by the neighbor searcher 301 without interference of the CPU 400. The ICMP relevant packet includes a Neighbor Discovery relevant packet and an ICMP error message. Upon receipt of this packet, the packet parser 310 transmits the packet to the neighbor searcher 301 (S601). The neighbor searcher 301 updates its list or processes the packet using information about the received packet, and transmits necessary information to the CPU 400. When intending for neighbor searching or when the received packet has an error, the ICMP packet is created and transmitted to the outside. In this case, the neighbor searcher 301 directly creates a packet and transmits the packet to the network interface 390 (S610), and transmits only necessary information to the CPU 400 (S602).

The present invention implements hardware supporting Mobile IPv6, thereby rapidly detecting movement when the MN moves to a new link, transmitting packets needed for Binding, and rapidly processing the resulting Acknowledgment packet. Hence, effective mobility support is possible, and all functionalities for the mobility support are processed by the hardware without interference of the CPU. Therefore, a mobility support processing speed is very high, and the CPU can be devoted to an application program. Consequently, it is possible to expect an overall improvement in the performance of the node.

While the present invention has been described with reference to the exemplary embodiments, it should be understood to those skilled in the art that various modifications can be made within the spirit and scope of the present invention as defined by the following claims.

What is claimed is:

1. A Mobile Internet Protocol version 6 (IPv6) reception module of a device supporting Mobile IPv6 for a mobile node adapted to communicate with a correspondent node using IPv6, the Mobile IPv6 reception module comprising:
a mobile reception processor adapted to output either home addresses of the mobile node and the correspondent node or mobility relevant header information according to whether a received packet is a Binding packet or a data packet;
a binding cache adapted to store Binding information received by the mobile node;
a binding update list adapted to store Binding information transmitted by the mobile node; and
a binding receiver adapted to receive a Binding message created by the correspondent node, to receive information on the home addresses of the mobile node and the correspondent node from the mobile reception processor, and to provide information related to the Binding message to the binding cache and the binding update list.

2. The Mobile IPv6 reception module according to claim 1, wherein the binding receiver is adapted to transmit information on at least one of the home address of the mobile node, the home address of the correspondent node, a care-of address of the correspondent node, a sequence number, and a lifetime to the binding cache upon the Binding message being a Binding Update message; and to transmit information on at least one of the home address of the mobile node, a care-of address of the mobile node, the home address of the correspondent node, a sequence number, a lifetime, and status information to the binding update list upon the Binding message being a Binding Acknowledgment message.

3. The Mobile IPv6 reception module according to claim 1, further comprising an IPv6 receiver adapted to effect IPv6 header processing.

4. The Mobile IPv6 reception module according to claim 3, wherein the mobile reception processor is adapted to transmit the home addresses of the mobile node and the correspondent node to the binding receiver upon the received packet being a Binding packet, and to transmit an IP header having a mobility relevant part thereof removed to the IPv6 receiver upon the received packet being a data packet.

5. The Mobile IPv6 reception module according to claim 1, further comprising a checksum verifier adapted to verify whether or not a checksum of an externally input packet matches a calculated checksum.

6. The Mobile IPv6 reception module according to claim 5, wherein the mobile reception processor is adapted to create a pseudo header for calculating the checksum, and to provide the pseudo header to the checksum verifier.

7. The Mobile IPv6 reception module according to claim 1, further comprising a node status detector adapted to detect a current status of the mobile node with respect to whether the mobile node is currently located on a home link or a foreign link.

8. The Mobile IPv6 reception module according to claim 1, further comprising a packet parser adapted to sort headers of packets received from external Media Access Control (MAC) by types, to transmit the sorted headers to either the mobile reception processor or the binding receiver, and to extract and output data except for the header.

9. The Mobile IPv6 reception module according to claim 8, further comprising a reception Random Access Memory (RAM) adapted to receive and store the data extracted and output from the packet parser.

10. The Mobile IPv6 reception module according to claim 1, further comprising:
a User Datagram Protocol (UDP) receiver adapted to perform UDP header processing on the received packet; and
a Transmission Control Protocol (TCP) receiver adapted to perform TCP header processing on the received packet.

11. The Mobile IPv6 reception module according to claim 1, wherein the binding cache is adapted to store a Care-of Address (CoA) of the correspondent node in a table.

12. A Mobile Internet Protocol version 6 (IPv6) transmission module of a device supporting Mobile IPv6 for a mobile node adapted to communicate with a correspondent node using IPv6, the Mobile IPv6 transmission module comprising:
a binding transmitter adapted to receive a request for creation of a Binding message, to combine data using a calculated checksum, and to create and output a requested Binding message;
a binding cache adapted to store Binding information received by the mobile node;
a binding update list adapted to store Binding information transmitted by the mobile node; and
a mobile transmission processor adapted to determine a type of a header for Binding Update or Binding Acknowledgment through a Care-of Address (CoA) obtained by retrieving at least one of the binding cache and the binding update list, and to create and output a Mobile IPv6 header using home addresses of the mobile node and the correspondent node received from the binding transmitter.

13. The Mobile IPv6 transmission module according to claim 12, wherein the mobile transmission processor is adapted to retrieve only the binding cache upon the message to be created being a Binding Update message, and to retrieve only the binding update list upon the message to be created being a Binding Acknowledgment message.

14. The Mobile IPv6 transmission module according to claim 12, further comprising an IPv6 transmitter adapted to perform IPv6 header processing, and to output the IPv6 header to the mobile transmission processor.

15. The Mobile IPv6 transmission module according to claim 14, further comprising a network interface adapted to combine the header and application program data to create a packet, and to transmit the created packet to a foreign network.

16. The Mobile IPv6 transmission module according to claim 12, further comprising:
a User Datagram Protocol (UDP) receiver adapted to perform UDP header processing on the packet to be transmitted; and
a Transmission Control Protocol (TCP) receiver adapted to perform TCP header processing on the packet to be transmitted.

17. A device supporting Mobile Internet Protocol version 6 (IPv6) for a mobile node adapted to communicate with a correspondent node using IPv6, the device comprising:
a mobile reception processor adapted to output either home addresses of the mobile node and the correspondent node or mobility relevant header information according to whether a received packet is a Binding packet or a data packet;
a binding cache adapted to store Binding information received by the mobile node;
a binding update list adapted to store Binding information transmitted by the mobile node;
a binding receiver adapted to receive a Binding message created by the correspondent node, to receive information on the home addresses of the mobile node and the correspondent node from the mobile reception processor, and to provide information related to the Binding message to the binding cache and the binding update list;
a binding transmitter adapted to receive a request for creation of the Binding message, to combine data using a calculated checksum, and to create and output a requested Binding message; and
a mobile transmission processor adapted to determine a type of a header for Binding Update or Binding Acknowledgment through a Care-of Address (CoA) obtained by retrieving at least one of the binding cache and the binding update list, and to create and output a Mobile IPv6 header using the home addresses of the mobile node and the correspondent node received from the binding transmitter.

18. The device according to claim 17, further comprising:
a packet parser adapted to sort headers of the packets received from external Media Access Control (MAC) by types, to transmit the sorted headers to either the mobile reception processor or the binding receiver, and to extract and output data except for the header; and
a network interface adapted to combine the header and application program data to create a packet, and to transmit the created packet to a foreign network.

19. The device according to claim 18, further comprising a neighbor searcher adapted to perform MAC address retrieval from an Internet Protocol (IP) address, default router selection, neighbor unreachability detection, and movement detection.

20. The device according to claim 19, wherein the neighbor searcher is adapted to receive an Internet Control Message Protocol (ICMP) relevant message from the packet parser, to transmit necessary information to a Central Processing Unit (CPU) of the mobile node, to create an ICMP packet upon neighbor searching or the received packet giving rise to trouble, and to transmit the created ICMP packet to the network interface.
